(19) United States
(12) Patent Application Publication
(10) Pub. No.: US 2022/0221268 A1
(43) Pub. Date: Jul. 14, 2022

(54) MEASURING SYSTEM

(71) Applicant: M & H Inprocess Messtechnik GmbH, Waldburg (DE)

(72) Inventor: Christoph WIEST, Weingarten (DE)

(73) Assignee: M & H Inprocess Messtechnik GmbH, Waldburg (DE)

(21) Appl. No.: 17/651,635

(22) Filed: Feb. 18, 2022

Related U.S. Application Data
(63) Continuation of application No. PCT/EP2020/071665, filed on Jul. 31, 2020.

(30) Foreign Application Priority Data
Aug. 22, 2019 (DE) 10 2019 122 650.3

(51) Int. Cl. G01B 11/00; G01B 5/008

(52) U.S. Cl. CPC G01B 11/005; G01B 5/008

(57) ABSTRACT

A measuring system for detecting measured values by scanning, including a measuring instrument. The measuring system can be arranged on a movement axis of a machine tool or a measuring machine. An object is measured by the measuring instrument generating a measured value during the measurement of the object. The measuring system includes a control unit to process and store the measured value, and a memory unit to store the detected measured value. The measuring system correlates a first measured value with a first position coordinate of the measuring instrument and, starting from the correlation of the first measured value with the first position coordinate, assigns position coordinates uniquely to further measured values detected by the measuring instrument since a movement speed and a movement direction of the measuring instrument during or at the time of the detection of the measured values are known to the measuring system.

### CROSS REFERENCE TO RELATED APPLICATIONS

This application is a continuation of International Application No. PCT/EP2020/071665 filed Jul. 31, 2020, which designated the United States, and claims the benefit under 35 USC § 119(a)-(d) of German Application No. 10 2019 122 650.3 filed Aug. 22, 2019, the entireties of which are incorporated herein by reference.

### FIELD OF THE INVENTION

The present invention relates to a measuring system.

### BACKGROUND OF THE INVENTION

Measuring systems for scanning acquisition of measurement values are known.

A known measuring system comprises an optical measuring instrument which is in a form that is arrangeable on a machine bar of a tool or a measuring machine. A plurality of measurement values, for example, are able to be successively acquired in a time series by means of the optical measuring instrument. Should the measuring instrument be moved over an object to be measured during a measurement, different locations on the object to be measured hence can be measured by the measuring instrument during the movement of the measuring instrument. By way of example, a height profile of the object to be measured is generable as a result.

In this known measuring system, it is comparatively complicated to bring the generated measurement values into correspondence with the measured locations on the object, the measurement coordinates. In known measuring systems, the movement speed of the measuring instrument during the measurement correlates with a determination accuracy of the measurement location. The more accurately the measurement location is intended to be determined, the slower the measurement, or conversely, the faster the measurement, the less accurate the determination of the measurement location.

### SUMMARY OF THE INVENTION

The present invention is based on the object of providing an alternative measuring system for scanning acquisition of measurement values.

The starting point for the present invention is a measuring system for scanning acquisition of measurement values, the measuring system comprising a measuring instrument, the measuring system, in particular, the measuring instrument of the measuring system, being in a form that is arrangeable on a movement bar of a machine, the machine being in the form of a machine tool or a measuring machine, a measurement object being able to be measured by the measuring instrument, the measuring instrument generating a measurement value when measuring the measurement object, the measuring system comprising a controller unit, the controller unit being able to process and store the measurement value, the measuring system having a storage unit for storing the acquired measurement value.

Advantageously, the storage unit is present in the form of a conventional magnetic or electronic storage unit. By way of example, the storage unit is in the form of an electronic data memory. For example, the storage unit is present in the form of a DRAM storage unit, as a ROM storage unit or as a flash-EEPROM storage unit. The controller unit advantageously comprises a control module in the form of a computing unit, for example, a microcontroller or a microprocessor.

The machine is advantageously in the form of a machine tool or in the form of a measuring machine. By way of example, the machine is present in the form of a CNC processing center. For example, the machine tool is in the form of a turning and/or milling center. Advantageously, the machine tool comprises a plurality of machine bars that are movable relative to one another. By way of example, the machine tool is in the form of a 3-axis machine tool or in the form of a 5-axis machine tool. By way of example, the measuring machine is in the form of a coordinate measuring machine.

The core of the present invention should now be considered to be that the measuring system is designed to correlate a first measurement value with a first position coordinate of the measuring instrument arranged on the machine, the measuring system, using the correlation of the first measurement value with the first position coordinate as a starting point, being designed to assign position coordinates to further measurement values acquired by the measuring instrument simply by virtue of a movement speed and a movement direction of the measuring instrument during or at the instance of acquisition of the measurement values being known to the measuring system. As a result, a comparatively precise measurement of a measurement object within a comparatively short measurement time is realizable by the measuring system.

The movement direction and/or the movement speed of the measuring instrument is advantageously constant while the measurement values are acquired. By way of example, the measuring instrument is moved at a constant speed and/or in a constant direction by way of a movement bar or a plurality of movement bars of the machine during the acquisition of the measurement values.

Preferably, the movement direction and/or the movement speed of the measuring instrument should be considered relative to the measurement object to be measured. Correspondingly, it is conceivable that the measuring instrument is present at a fixed position relative to surroundings, for example, surroundings of a machine on which the measuring instrument is arranged, during a measurement and instead it is the measuring object that is moved relative to the measuring instrument and relative to the surroundings.

Preferably, every position coordinate assigned to a measurement value by the measuring system is a position coordinate of the measuring instrument arranged on the machine. Advantageously, the position coordinate of the measuring instrument arranged on the machine is transformable to a spatial coordinate of the measurement object, for example, by normalization. Advantageously, the spatial coordinate of the measurement object is a measurement location at which the measuring instrument has measured the measurement object and has generated the measurement value as a result.

It is further proposed that, using the correlation of the first measurement value with the first position coordinate as a starting point, the measuring system is designed to assign further position coordinates to further measurement values acquired by the measuring instrument by virtue of a spatial relationship between the acquired measurement values being known to the measuring system. Using the position coordinate of the first measurement value as a starting point, this renders a corresponding position coordinate to be relatively easily assignable to a further measurement value, in particular, to all further measurement values.

It is also found to be advantageous that, using the correlation of the first measurement value with the first position coordinate as a starting point, the measuring system is designed to assign further position coordinates to further measurement values acquired by the measuring instrument by virtue of a temporal relationship between the acquired measurement values being known to the measuring system. A movement speed and movement direction of the measuring instrument between the acquisition of two different measurement values of a measurement are advantageously known to the measuring system.

Preferably, a spatial and/or temporal interval between the captured measurement values is known to the measuring system. Advantageously, a spatial relationship should be understood to mean not only a spatial distance or a spatial spacing, but also a spatial direction, in particular, an associated spatial direction. By way of example, the measuring system assigns further position coordinates to further measurement values acquired by the measuring instrument, the assignment being made on the basis of the temporal relationship, for example, a time interval, and the known movement speed and movement direction of the measuring instrument. In particular, a spatial and/or temporal interval of the captured measurement values of a measurement is known to the measuring system. The measuring system advantageously generates measurement values which have a known temporal relationship to one another. By way of example, the measuring system, for example, the measuring instrument, generates measurement values at a spatial and/or temporal interval, in particular, at a constant spatial and/or temporal interval.

A spatial relationship and/or a temporal relationship between the first measurement value and a further measurement value is advantageously known to the measuring system. In particular, a spatial relationship and/or a temporal relationship between the first measurement value and all further measurement values is known to the measuring system. By way of example, a movement speed and a movement direction of the movement bar of the machine, in particular, of all movement bars of the machine, are known to the measuring system.

Advantageously, the measuring system is calibrated and/or normalized to a movement speed of a movement bar of the machine. In particular, the measuring system is calibrated and/or normalized to a plurality of movement speeds of a movement bar of the machine. As a result, a spatial distance between the measurement values is known to the measuring system. In particular, a spatial distance between the measurement values dependent on a cycle time of the measurement value acquisition or measurement value generation by the measuring instrument and, for example, dependent on the movement of the movement bar is known to the measuring system.

It is also advantageous that the measuring instrument is in the form of a contactlessly operating measuring instrument.

By way of example, the measuring instrument is present in the form of a measuring sensor. By way of example, the measuring instrument is in the form of a confocal-chromatic distance sensor, in the form of a laser scanner, and/or in the form of an imaging measuring instrument, for example, in the form of a CCD sensor. By way of example, the measuring instrument is present in the form of a line scanner. Advantageously, the measuring instrument is present in the form of a scanning measuring instrument, for example as a scanner. By way of example, the measuring instrument generates measurement values point-by-point, line-by-line or row-by-row during a measurement.

However, it is also imaginable that the measuring instrument is in the form of a contacting measuring sensor, in particular, a measuring sensor operating on tactile principles. By way of example, the measuring instrument is designed to determine a deflection quantity of a sensing element of the measuring sensor operating on tactile principles and/or a force of the sensing element of the measuring sensor operating on tactile principles.

It is moreover advantageous that the measuring system has an interface for connecting the measuring system to a control unit of the machine, the controller unit having a control module which reads position coordinates, more particularly position coordinates of the measuring instrument, from the machine via the interface, the control module comparing the read position coordinate with a specified coordinate target range and the control module triggering a trigger signal should the control module determine that the position coordinate is located in the coordinate target range. This renders a measurement duration or a measurement length by the measuring system specifiable or controllable.

By way of example, the control unit of the machine is in the form of a numerical control, for example, as a CNC (computerized numerical control).

Advantageously, the measuring system is connectable to the machine by means of the interface, in such a way that current position coordinates of the measuring instrument, in particular, are readable by the measuring system. By way of example, the measuring system comprises a timer. By way of example, a timer of the measuring system and a timer of the machine are synchronizable with one another. By way of example, a temporal retardation, for example a delay, between a query time for a position coordinate and a reception time of the position coordinate is known to the measuring instrument. The measuring instrument advantageously comprises a timer.

The interface is advantageously in the form of a serial interface. The communication between measuring system and the machine is advantageously based on a synchronous, serial protocol. It is also conceivable that the interface is in the form of a standard interface, for example, in the form of a standard databus. By way of example, the interface is present as a fieldbus, for example as a Profinet interface, as an EnDat interface or as an Ethernet interface. By way of example, the interface is in the form of an SPI (serial peripheral interface). Moreover, it is advantageous for the interface to have a transmission channel for serial data communication with the machine. By way of example, the transmission channel is present in the form of a signal line. By way of example, the interface is in the form of a serial and/or parallel interface. Advantageously, the interface is present in the form of a USB interface or in the form of a FireWire interface.

It was also found to be advantageous for the interface to be a wired interface. This realizes a comparatively secure transmission path. It was likewise found to be advantageous for the interface to have a transmission channel for supplying the control unit with power and a transmission channel for transferring measurement signals.

Preferably, the control module is designed to compare the read position coordinate with a specified coordinate target region. By way of example, the control module is designed to trigger a trigger signal if the control module determines that the position coordinate, more particularly the currently read position coordinate, is located in the coordinate target region.

It is furthermore proposed that the measuring system has an interface for connecting the measuring system to a control unit of the machine, the measuring system comprising a timer, the controller unit having a control module, the control module comparing a time from the timer with a specified time and the measuring system triggering the trigger signal should the time from the timer reach or pass the specified time. As a result, a position coordinate of the machine, in particular, a measurement coordinate of the measurement object, is assignable to a measurement value of the measuring instrument. This also makes it possible to trigger a control command to the machine.

By way of example, a start time of a measurement and a measurement duration of the measurement is known to, and/or specifiable for, the measuring system. By way of example, the measuring system is designed to determine the specified time starting from the start time and the measurement duration. It is also conceivable that a start time of a measurement, a movement speed of the movement bar of the machine and a measurement path are known to the measuring system. By way of example, the measuring system is designed to determine the specified time starting from the start time, the movement speed of the movement bar and the measurement path. It is also imaginable that the measuring system is designed in such a way that the specified time is specifiable for the measuring system.

Moreover, it is advantageous that the controller unit stores the trigger signal in the storage unit together with a measurement value acquired at the time of the trigger signal, a temporal relationship between trigger signal and the measurement value being known to the measuring system. This facilitates an assignment of the measurement value to an associated measurement location, for example, a position coordinate.

A delay or a retardation time between trigger signal and reception of the measurement value from the measuring instrument is advantageously known to the measuring system. In particular, this delay or this retardation is constant.

Preferably, the measuring system comprises a transmitter and receiver unit in addition to the measuring instrument, the transmitter and receiver unit being designed to receive and process measurement values generated by the measuring instrument. It is conceivable that the transmitter and receiver unit has the interface. It is also imaginable that the controller unit is a constituent part of the transmitter and receiver unit. By way of example, the transmitter and receiver unit is coupled to the measuring instrument by way of a radio connection and/or by way of an optical connection.

By way of example, the transmitter and receiver unit is in the form of a control and evaluation unit for the measuring instrument. Advantageously, the control and evaluation unit controls the measuring instrument. By way of example, the control and evaluation unit is designed to evaluate measurement data from the measuring instrument, in particular, to determine a measurement value from the measurement data of the measuring instrument.

By way of example, the controller unit and/or the transmitter and reception unit communicate with the measuring instrument via a wireless communication channel. By way of example, the controller unit and/or the transmitter and reception unit communicate with the measuring instrument by means of optical signals and/or by means of radio signals. By way of example, the optical signals are infrared signals. By way of example, the radio signals are Bluetooth signals.

Further, it is proposed that the transmitter and receiver unit and the measuring instrument communicate with one another by means of a radio connection. Preferably, the controller unit and/or the transmitter and receiver unit and the measuring instrument communicate by means of a WLAN interface, a Bluetooth interface and/or a mobile radio interface. By way of example, the mobile radio interface is present in the form of an LTE interface.

It is also conceivable that the controller unit is in the form of a computing unit that is separate from the measuring instrument and/or the transmitter and receiver unit, for example, in the form of a computer. Preferably, as a separate computing unit, the controller unit is connectable both to the machine and to the transmitter and receiver unit and/or the measuring instrument. In an imaginable embodiment of the measuring system, the measuring instrument comprises the controller unit and/or an interface, by means of which the measuring instrument is connectable to the control unit of the machine.

It was also found to be advantageous that the measurement value captured at the time of the trigger signal is the first measurement value. By way of example, the measuring instrument terminates the measurement value acquisition after triggering the trigger signal. For example, the first measurement value is the last-generated measurement value of the measurement from a temporal point of view. By way of example, the first measurement value is the last measurement value of the measurement processed by the controller unit from a temporal point of view.

In an advantageous embodiment of the present invention, the measuring system, in particular, the controller unit of the measuring system, is designed to transmit the trigger signal to the control unit of the machine via an interface, in particular, via a further interface. As a result, it is possible to arrest the movement of the movement bar of the machine.

The measuring system preferably comprises two interfaces, the trigger signal being transmitted by the measuring system to the control unit of the machine via a first interface and the measuring system reading position coordinates from the machine via a second interface. Advantageously, the two interfaces are present physically separated from one another. By way of example, the two interfaces are designed differently from one another. By way of example, the controller unit comprises the second interface. It is also conceivable that the transmitter and receiver unit or the measuring instrument has the first interface. By way of example, the first interface is in the form of a proprietary interface. By way of example, the first interface is designed to facilitate serial data transfer.

If the controller unit is in the form of a separate computing unit, the measuring system advantageously comprises a further, third interface, by means of which the measuring instrument is connected to the controller unit. By way of example, the measuring instrument transmits the measurement values to the controller unit via the third interface. It is conceivable that the transmitter and receiver unit has the third interface. By way of example, the transmitter and receiver unit is physically connected to the controller unit by means of the third interface.

By way of example, the control unit of the machine and the measuring system, in particular, the measuring instrument, communicate via a wireless communications channel. By way of example, the control unit of the machine and the measuring system communicate by means of optical signals and/or by means of radio signals. By way of example, the optical signals are infrared signals. By way of example, the radio signals are Bluetooth signals. Further, it is proposed that the control unit of the machine and the measuring system, in particular, the measuring instrument, communicate with one another by means of a radio connection. Preferably, the control unit of the machine and the measuring system communicate by means of a WLAN interface, a Bluetooth interface and/or a mobile radio interface. By way of example, the mobile radio interface is present in the form of an LTE interface.

It is also advantageous that the measuring system is designed to read a first position coordinate, in particular a position coordinate of the measuring instrument arranged at the machine, from the machine, said first position coordinate being acquired at the time of the trigger signal, a temporal relationship between trigger signal and the first position coordinate being known to the measuring system, the controller unit of the measuring system being designed to establish a temporal relationship between the first position coordinate and the first measurement value. As a result, the creation of a height profile of the measured measurement object is realizable.

By way of example, a delay, for example, a temporal delay between the output of the trigger signal by the controller unit of the measuring system to the machine and correlation of the trigger signal with a position coordinate by the machine, is known to the measuring system. Advantageously, the machine is designed to correlate the trigger signal with a position coordinate or to link the trigger signal to a position coordinate. Advantageously, this temporal delay is approximately constant, in particular.

An advantageous variant of the present invention is a machine, more particularly a machine tool and/or measuring machine, comprising a measuring system according to any one of the aforementioned embodiments, the machine being embodied to stop an axial movement on account of a trigger signal from the measuring system. As a result, a measurement process is rendered controllable by the measuring system.

Advantageously, the machine is designed to stop an axial movement on account of the trigger signal triggered by the measuring system.

A further advantageous embodiment of the present invention is a machine, more particularly a machine tool and/or measuring machine, as specified above, the control unit of the machine storing, in a storage module of the machine in readable fashion, an axial position at the time of reception of a trigger signal of the measuring system.

Advantageously, the control unit of the machine tool and/or the control unit of the measuring machine stores an axial position at the time of reception of the trigger signal in the storage module of the machine tool and/or in the storage module of the measuring machine, together with the trigger signal. By way of example, the axial position at the time of reception of the trigger signal is readably storable, in a manner identifiable for the measuring system, in the storage module of the machine tool and/or in the storage module of the measuring machine.

It is also imaginable that the controller unit is present at the machine. It is also conceivable that the controller unit is a constituent part of the machine. By way of example, the controller unit is a component of the control unit. For example, the control unit comprises the controller unit.

### BRIEF DESCRIPTION OF THE DRAWINGS

A plurality of exemplary embodiments are described in more detail on the basis of the following schematic drawings, with further details and advantages being specified:

FIG. 1 shows a schematic illustration of a machine comprising a measuring system according to a first embodiment variant;

FIG. 2 shows a schematic illustration of a machine comprising a measuring system according to a second embodiment variant; and

FIG. 3 shows a schematic illustration of a machine comprising a measuring system according to a third embodiment variant.

### DETAILED DESCRIPTION OF THE INVENTION

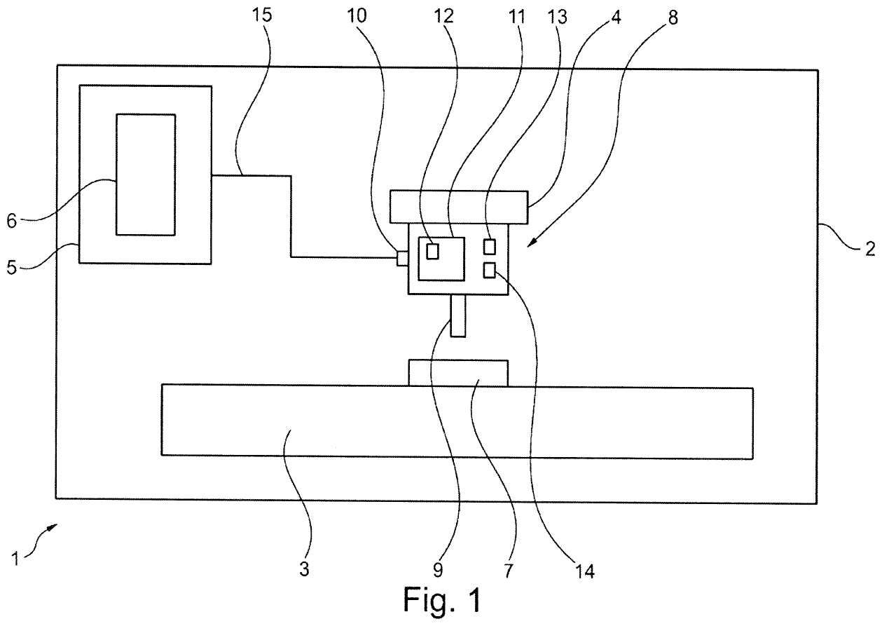

FIG. 1 shows a schematically illustrated machine 1 with a housing 2, a machine table 3, a movement bar 4 and a control unit 5. By way of example, the machine 1 comprises a storage module 6 which is present at the control unit 5, for example. A measurement object 7 is arranged on the machine table 3 in exemplary fashion.

Advantageously, a measuring system 8 is present in a manner arranged on the machine 1. The measuring system 8 comprises a measuring instrument 9, an interface 10 and a controller unit 11. By way of example, the controller unit 11 has a control module 12. Moreover, the measuring system 8 may comprise a storage unit 13 and a timer 14.

In the embodiment variant according to FIG. 1, the further components of the measuring system 8, such as, for example, the controller unit 11, form a separate compact unit in addition to the measuring instrument 9. According to FIG. 1, the further components of the measuring system 8 are in the form of a compact unit, for example, in a manner arrangeable in a single housing on the movement bar 4 of the machine 1.

By way of example, the measuring system 8 is connected via the interface 10 to the control unit 5 of the machine 1 by means of a transmission channel 15.

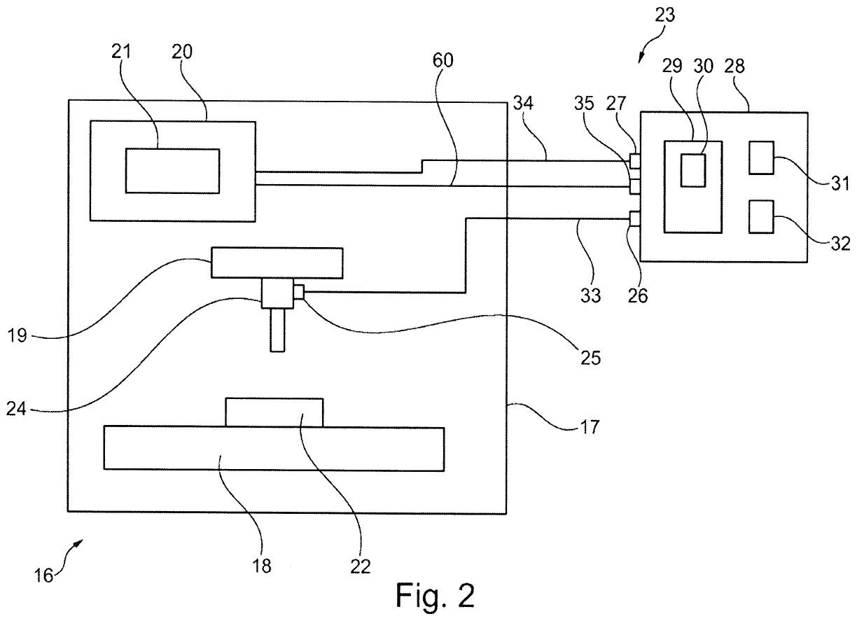

In a further embodiment variant, FIG. 2 shows a machine 16 with a schematically illustrated housing 17, a machine table 18, a movement bar 19 and a control unit 20. By way of example, the machine 16 comprises a storage module 21 which is present at the control unit 20, for example. A measurement object 22 is arranged on the machine table 18 in exemplary fashion.

Advantageously, a measuring system 23 is arranged on the machine 16. The measuring system 23 comprises a measuring instrument 24, a first interface 25, a second interface 26 and, for example, a third interface 27. Further, the measuring system 23 comprises a transmitter and receiver unit 28, for example. By way of example, the transmitter and receiver unit 28 has a controller unit 29 with a control module 30. Moreover, the measuring system 23 may comprise a storage unit 31 and a timer 32.

In the embodiment variant according to FIG. 2, the measuring instrument 24 is coupled in exemplary fashion to the transmitter and receiver unit 28 via the interfaces 25, 26 by means of a transmission channel 33. By way of example, the transmission channel 33 is present in the form of a wireless transmission channel. By way of example, the transmission channel 33 is in the form of a radio connection or a radio channel. It is also conceivable that the transmission channel 33, in particular in the form of a signal line, is in the form of an optical connection, for example, as an optical transmission channel. Moreover, the transmitter and receiver unit 28 is connected via a further transmission channel 34 to the machine 16, in particular, the control unit 20 of the machine 16, by means of the interface 28.

In accordance with the embodiment variant according to FIG. 2, it is further imaginable that a further interface 35 is present at the transmitter and receiver unit 28, the transmitter and receiver unit 28 being able to be connected via a further transmission channel 60 to the machine 16 by means of the interface 35.

It is further conceivable that one of the two interfaces 27, 35 is in the form of a standard interface, for example, in the form of a USB or network interface. By way of example, this interface is designed to query position coordinates from the machine 16 by the controller unit 29. It is further imaginable that the other of the two interfaces 27, 35 is in the form of a proprietary interface. If the other interface 27, 35 is in the form of a propriety interface, it is advantageous that the controller unit 29 is able to communicate with the machine 16 by means of the proprietary interface and by means of a serial data transfer.

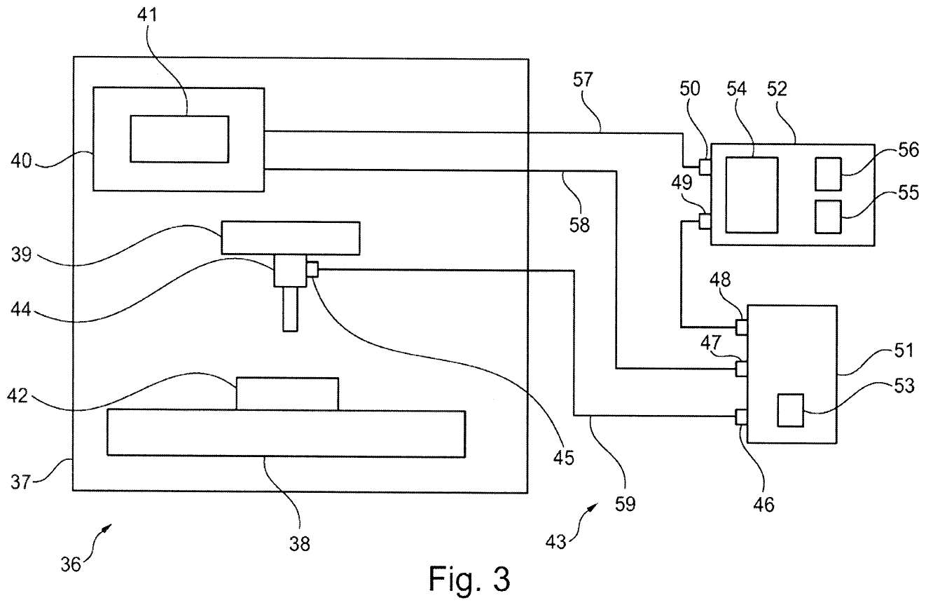

In a further embodiment variant, FIG. 3 shows a machine 36 with a schematically illustrated housing 37, a machine table 38, a movement bar 39 and a control unit 40. By way of example, the machine 36 comprises a storage module 41 which is present at the control unit 40, for example. A measurement object 42 is arranged on the machine table 38 in exemplary fashion.

Advantageously, a measuring system 43 is arranged on the machine 36. The measuring system 43 comprises a measuring instrument 44 and interfaces 45 to 50. Further, the measuring system 43, for example, comprises a transmitter and receiver unit 51 and a controller unit 52. The transmitter and receiver unit 51 and the controller unit 52 are advantageously present at a distance from one another and are coupled to one another by means of the interfaces 48, 49, for example, via a USB connection or an Ethernet connection or network connection. By way of example, the controller unit 52 is present as a computer, for example, as a laptop.

By way of example, the transmitter and receiver unit 51 comprises a timer 53. It is also conceivable for the controller unit 52 to have a timer (not shown).

The controller unit 52 has a control module 54 and, for example, a storage unit 55. It is likewise imaginable that the transmitter and receiver unit 51 comprises a storage unit (not shown).

It is further imaginable that the interface 50 is in the form of a standard interface, for example, in the form of a USB or network interface with a corresponding transmission channel 57. By way of example, this interface 50 is designed to query and read position coordinates from the machine 36 by the controller unit 52. It is further imaginable that the controller unit 52 comprises a timer 56, the controller unit 52, more particularly the control module 54, monitoring and checking whether a time of the timer 56 has reached or passed a specified time and/or whether a read position coordinate is located in a specified coordinate target range.

The interface 47 of the transmitter and receiver unit 51 is advantageously in the form of a proprietary interface, so as to transmit a trigger signal to the control unit 40 of the machine 36 by means of a further transmission channel 58. By way of example, the trigger signal is transmittable to the machine 36 by means of a serial data transfer.

In the embodiment variant according to FIG. 3, the measuring instrument 44 is coupled in exemplary fashion to the transmitter and receiver unit 51 by means of the interfaces 45, 46 and via a transmission channel 59. By way of example, the transmission channel 59 is present in the form of a wireless transmission channel. By way of example, the transmission channel 59 is in the form of a radio connection or a radio channel. It is also conceivable that the transmission channel 59 is in the form of an optical connection, for example, as an optical transmission channel.

### LIST OF REFERENCE SIGNS

1 Machine
2 Housing
3 Machine table
4 Movement bar
5 Control unit
6 Storage module
7 Measurement object
8 Measuring system
9 Measuring instrument
10 Transmission channel
11 Controller unit
12 Control module
13 Storage unit
14 Timer
15 Transmission channel
16 Machine
17 Housing
18 Machine table
19 Movement bar
20 Control unit
21 Storage module
22 Measurement object
23 Measuring system
24 Measuring instrument
25 Transmission channel
26 Transmission channel
27 Transmission channel
28 Transmitter and receiver unit
29 Controller unit
30 Control module
31 Storage unit
32 Timer
33 Transmission channel
34 Transmission channel
35 Interface
36 Machine
37 Housing
38 Machine table
39 Movement bar
40 Control unit
41 Storage module
42 Measurement object
43 Measuring system
44 Measuring instrument
45 Interface
46 Interface
47 Interface
48 Interface
49 Interface
50 Interface
51 Transmitter and receiver unit
52 Controller unit
53 Timer
54 Control module
55 Storage unit
56 Timer
57 Transmission channel
58 Transmission channel
59 Transmission channel
60 Transmission channel

1. A measuring system for scanning acquisition of measurement values, the measuring system comprising a measuring instrument, the measuring system being in a form that is arrangeable on a movement bar of a machine, the machine being in the form of a machine tool or a measuring machine, a measurement object being able to be measured by the measuring instrument, the measuring instrument generating a measurement value when measuring the measurement object, the measuring system comprising a controller unit, the controller unit being able to process and store the measurement value, the measuring system having a storage unit for storing the acquired measurement value,
wherein the measuring system is designed to correlate a first measurement value with a first position coordinate of the measuring instrument arranged on the machine, the measuring system, using the correlation of the first measurement value with the first position coordinate as a starting point, being designed to assign position coordinates to further measurement values acquired by the measuring instrument simply by virtue of a movement speed and a movement direction of the measuring instrument during or at the instance of acquisition of the measurement values being known to the measuring system.

2. The measuring system as claimed in claim 1, wherein, using the correlation of the first measurement value with the first position coordinate as a starting point, the measuring system is designed to assign further position coordinates to further measurement values acquired by the measuring instrument by virtue of a spatial relationship between the acquired measurement values being known to the measuring system.

3. The measuring system as claimed in claim 1, wherein, using the correlation of the first measurement value with the first position coordinate as a starting point, the measuring system is designed to assign further position coordinates to further measurement values acquired by the measuring instrument by virtue of a temporal relationship between the acquired measurement values being known to the measuring system.

4. The measuring system as claimed in claim 1, wherein the measuring instrument is in the form of a contactlessly operating measuring instrument.

5. The measuring system as claimed in claim 1, wherein the measuring system has an interface for connecting the measuring system to a control unit of the machine, the controller unit having a control module which reads position coordinates from the machine via the interface, the control module comparing the read position coordinate with a specified coordinate target range and the control module triggering a trigger signal should the control module determine that the position coordinate is located in the coordinate target range.

6. The measuring system as claimed in claim 1, wherein the measuring system has an interface for connecting the measuring system to a control unit of the machine, the measuring system comprising a timer, the controller unit having a control module, the control module comparing a time from the timer with a specified time and the measuring system triggering the trigger signal should the time from the timer reach or pass the specified time.

7. The measuring system as claimed in claim 5, wherein the controller unit stores the trigger signal in the storage unit together with the measurement value acquired at the time of the trigger signal, a temporal relationship between trigger signal and measurement value being known to the measuring system.

8. The measuring system as claimed in claim 5, wherein the measurement value acquired at the time of the trigger signal is the first measurement value.

9. The measuring system as claimed in claim 5, wherein the controller unit is designed to transmit the trigger signal to the control unit of the machine via an interface.

10. A machine comprising a measuring system as claimed in claim 1, wherein the machine is designed to stop an axial movement of the movement bar on account of a trigger signal from the measuring system.

11. The machine as claimed in claim 10, wherein the control unit of the machine stores, in a storage module of the machine in readable fashion, an axial position at the time of reception of a trigger signal of the measuring system.
